(19) United States
(12) Patent Application Publication
(10) Pub. No.: US 2025/0256651 A1
(43) Pub. Date: Aug. 14, 2025

(54) REARVIEW MIRROR AND VEHICLE

(71) Applicant: Shanghai Tianma Microelectronics Co., Ltd., Shanghai (CN)

(72) Inventors: Donghua CHEN, Shanghai (CN); Yuan DING, Shanghai (CN)

(21) Appl. No.: 19/194,036

(22) Filed: Apr. 30, 2025

(30) Foreign Application Priority Data
Dec. 30, 2024 (CN) 202411981838.3

(51) Int. Cl. B60R 1/25; B60K 35/22; B60K 35/60; B60K 35/81; B60R 1/08

(52) U.S. Cl. CPC B60R 1/25; B60K 35/22; B60K 35/60; B60K 35/81; B60R 1/08; B60K 2360/23; B60K 2360/349; B60K 2360/48; B60K 2360/779; B60R 2300/8046

(57) ABSTRACT

A rearview mirror and a vehicle. The rearview mirror includes a reflective assembly and a display assembly. States of the rearview mirror include a reflective state and a display state. In the reflective state, the reflective assembly is activated to reflect ambient light into a user's field of view. In the display state, the display assembly is activated to acquire ambient light and generate an environmental image for display. The rearview mirror can switch between the reflective state and the display state based on environmental changes. In the reflective state, the reflective assembly is activated to reflect ambient light to the user's field of view; and in the display state, the display assembly is activated to acquire ambient light and generate an environment image for display, to improve the clarity of the image displayed on the rearview mirror and improve the driving safety of the user.

### CROSS-REFERENCE TO RELATED APPLICATIONS

The present application claims priority to Chinese Patent Application No. 202411981838.3, filed on Dec. 30, 2024, the content of which is incorporated herein by reference in its entirety.

### TECHNICAL FIELD

The present disclosure relates to the technical field of display, and in particular, to a rearview mirror and a vehicle.

### BACKGROUND

A rearview mirror is an important component of a vehicle. Typically, the vehicle includes a left rearview mirror and right rearview mirror, and a driver observes conditions behind or beside the vehicle through the rearview mirror to know real-time conditions of these positions.

At present, most vehicles are equipped with traditional light-reflective glass rearview mirrors. These mirrors are unable to present the true conditions behind or beside the vehicle during a darkness condition or under an insufficient lighting condition. Some vehicles adopt electronic rearview mirrors, referring to FIG. 1, that is, a camera is provided at a position of the traditional rearview mirror, and a display screen is provided in the vehicle to display images acquired by the camera. However, the position of the existing electronic rearview mirror does not coincide with the position of the traditional rearview mirror, thus not conforming to driver's conventional driving habits. Additionally, there is a risk of failure of the electronic rearview mirror, which may prevent the driver from operating the vehicle properly.

Therefore, the currently existing vehicle-mounted rearview mirror has some potential safety hazards in the driving process of the driver, and cannot meet the safe driving requirements of the driver in various complex environments.

### SUMMARY

The present disclosure provides a rearview mirror and a vehicle, which can control the rearview mirror to switch in a reflective state and a display state based on environment changes, thereby improving the clarity of an image displayed by the rearview mirror, and thus improving the driving safety.

An embodiment of the present disclosure provides a rearview mirror, including: a reflective assembly; and a display assembly. States of the rearview mirror include a reflective state and a display state; in the reflective state, the reflective assembly is activated and configured to reflect ambient light to a field of view of a user; and in the display state, the display assembly is activated and configured to acquire ambient light and generate an environment image for display.

Based on a same concept, an embodiment of the present disclosure further provides a vehicle, including the rearview mirror as described in the first aspect.

According to the rearview mirror provided by the embodiments of the present disclosure, the rearview mirror can switch between the reflective state and the display state based on environmental changes. In the reflective state, the reflective assembly is activated to reflect ambient light to the user's field of view; and in the display state, the display assembly is activated to acquire ambient light and generate an environment image for display, thereby improving the clarity of the image displayed on the rearview mirror and improving the driving safety of the user.

### BRIEF DESCRIPTION OF DRAWINGS

FIG. 1 is a structural diagram of a rearview mirror in the related art;

FIG. 2 is a structural diagram of a rearview mirror according to an embodiment of the present disclosure;

FIG. 3 is a structural diagram of another rearview mirror according to an embodiment of the present disclosure;

FIG. 4 is a structural diagram of another rearview mirror according to an embodiment of the present disclosure;

FIG. 5 is a structural diagram of another rearview mirror according to an embodiment of the present disclosure;

FIG. 6 is a structural diagram of another rearview mirror according to an embodiment of the present disclosure;

FIG. 7 is a diagram illustrating a rearview mirror being applied in a vehicle according to an embodiment of the present disclosure;

FIG. 8 is a diagram illustrating a display screen being located at a side window glass according to an embodiment of the present disclosure;

FIG. 9 is a diagram illustrating closing and opening of the display screen in the front side window glass shown in FIG. 8;

FIG. 10 is an another diagram illustrating a display screen being located at a side window glass according to an embodiment of the present disclosure; and

FIG. 11 is a diagram illustrating a display screen being located in a door of a vehicle according to an embodiment of the present disclosure.

### DESCRIPTION OF EMBODIMENTS

The present disclosure will be further described in detail below with reference to the accompanying drawings and embodiments. It can be understood that the specific embodiments described herein are only used to explain the present disclosure, rather than making any limitation on the present disclosure. In addition, it should also be noted that, for the convenience of description, only some but not all structures related to the present disclosure are shown in the accompanying drawings.

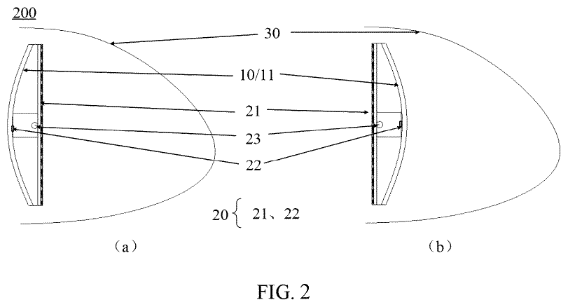

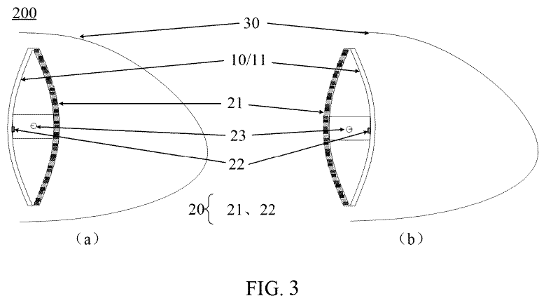

Based on this, an embodiment of the present disclosure provides a rearview mirror, to meet a display function of left and right rearview mirrors of a vehicle. FIG. 2 is a side view of a rearview mirror according to an embodiment of the present disclosure. FIG. 3 is a structural diagram of another rearview mirror according to an embodiment of the present disclosure. Referring to FIG. 2 and FIG. 3, the rearview mirror according to the embodiments of the present disclosure includes a reflective assembly 10 and a display assembly 20, and the rearview mirror has a reflective state and a display state. FIG. 2 (a) and FIG. 3 (a) illustrate the reflective state of the rearview mirror, and FIG. 2 (b) and FIG. 3 (b) illustrate the display state of the rearview mirror. The rearview mirror can switch between the reflective state and the display state in combination with the light brightness, the driving experience of a driver during driving and the like. FIG. 2 (a) refers to (a) shown in FIG. 2, FIG. 2 (b) refers to (b) shown in FIG. 2, and other figures will not be explained herein again.

The reflective assembly 10 and the display assembly 20 may be assembled together in a rearview mirror housing 30. The rearview mirror housing 30 is conventionally mounted at a left side and a right side of a vehicle, and a driver can observe side and rear conditions of the vehicle from the rearview mirror through conventional driving habits.

Referring to FIG. 2 (a) and FIG. 3 (a), when the ambient light is sufficient, the rearview mirror switches to the reflective state, the reflective assembly 10 is activated, and the reflective assembly 10 is used to reflect the ambient light to the user's field of view. The reflective state refers to the same function as a conventional vehicle-mounted rearview mirror, the reflective assembly 10 reflects the light emitted, reflected, or diffusely reflected from the surroundings at two sides and the rear of the vehicle into the driver's field of view. The driver observes the real conditions at two sides and the rear of the vehicle through the reflective assembly 10. Exemplarily, when the vehicle travels in the daytime with sufficient ambient light, and the driver can clearly see the road conditions at two sides and the rear of the vehicle by viewing the reflective assembly 10, it is only necessary to activate the reflective state of the rearview mirror. This state can provide the driver with a clear view of the road conditions, so as to meet the driving experience under normal circumstances.

Referring to FIG. 2 (b) and FIG. 3 (b), when the reflective assembly 10 is unable to reflect sufficient light to obtain the road conditions, the rearview mirror switches to the display state, the display assembly 20 is activated and configured to acquire ambient light and generate environment images for display. The display state refers to that the display assembly 20 displays after acquiring ambient light of road condition images at two sides and the rear of the vehicle and generating an environment image, so that a driver can observe real conditions around and behind the vehicle during driving.

Exemplarily, when the vehicle travels at night with insufficient lighting, the rearview mirror switches to the display state, and the display assembly 20 can generate a high-clarity environment image, which has the advantage of high brightness and high clarity, thereby helping the driver to drive safely in a dark environment. However, it should be noted that, in the present disclosure, the reflective assembly 10 and the display assembly 20 are used in a switching manner, and the display assembly 20 is not used within a full period, so that on one hand, energy can be saved, and on the other hand, it is considered that in a high-brightness environment, a display screen of the display assembly 20 needs to work at particularly high brightness, which easily results in reduction of a service life of the display screen, and a display effect after long-term use is less than a display effect of the reflective assembly. Therefore, the rearview mirror provided in the embodiments of the present disclosure can accommodate different environments and match appropriate working states, thereby enhancing the imaging performance of the rearview mirror and extending the service life of the rearview mirror.

It should be noted that the rearview mirror further includes a processor. The processor may be an independent controller and independently control the rearview mirror in an in-vehicle application, or may be a part of a control circuit or a control unit of a total vehicle controller. The processor is connected to the display assembly 20, and is configured to control the display assembly 20 to obtain ambient light and generate an environment image for display. The processor may be a computing control unit, and may be one or more chips or circuits having a central processing unit (CPU), a graphics processing unit (GPU), a field-programmable gate array (FPGA), and the like with functions such as computation, storage, and information transmission. Its function is to receive information, calculate, analyze, send signals and control display assembly 20, etc.

In summary, different from the rearview mirror in the related art, the rearview mirror provided in the embodiments of the present disclosure can switch between the reflective state and the display state, thereby providing clear road condition information for the driver during driving and improving driving safety of the driver.

Referring to FIG. 2 and FIG. 3, the reflective assembly 10 includes reflective glass 11, and the display assembly 20 includes a display screen 21 and an image collector 22. The image collector 22 is configured to obtain the ambient light and generate an environment image, and the display screen 21 is configured to display the environment image.

The reflective glass 11 may be glass coated with a reflective film as provided in a conventional vehicle-mounted rearview mirror. The display screen 21 includes, but is not limited to, a liquid crystal display (LCD), a light emitting diode display (LED), a micro light emitting diode display (Micro LED), an organic light emitting diode display (OLED), and the like, and the type of the display screen 21 is not specifically limited in the embodiments of the present disclosure. The image collector 22 includes, but is not limited to, a charge-coupled device (CCD) and a complementary metal-oxide-semiconductor (CMOS) sensor, and can collect the ambient light and generate the ambient image.

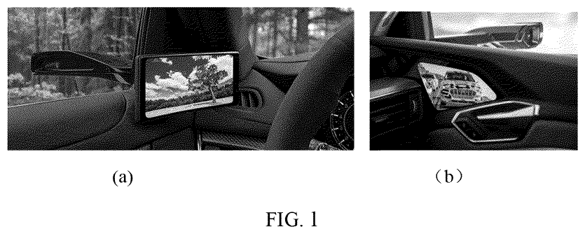

Referring to FIG. 2 and FIG. 3, a light-exiting side of the display screen 21 is a side of the display screen 21 facing away from the reflective glass 11. The image collector 22 is located between the display screen 21 and the reflective glass 11. The display screen 21 and the reflective glass 11 are turned over with a central rotation axis 23 as a base point. The axis of the central rotating axis 23 is formed as a line. FIG. 1 and FIG. 2 are only sectional views perpendicular to the central rotating axis 23. The rearview mirror housing 30 may be similar to a traditional rearview mirror. In the embodiments of the present disclosure, the reflective glass 11 and the display screen 21 are combined in a back-to-back manner, while the central rotating axis 23 is arranged in the middle, and the image collector 22 is hidden at the position of the central rotating axis 23. Exemplarily, the image collector 22 may be hidden behind the display screen 21 by using an under-display camera (UDC) technology, so that the image collector 22 does not block the environment image, thereby improving the user's visual experience.

Referring to FIG. 2 (a) and FIG. 3 (a), when the rearview mirror switches to the reflective state, the reflective glass 11 is turned to a side to face the ambient light and face the user. Exemplarily, when the surrounding environment is bright, for example, during daytime, the reflective state of the rearview mirror is activated, and if the display screen 21 faces the driver at this time, the reflective glass 11 is turned to a side to face the ambient light and face the driver by taking the central rotation axis 23 as a base point. If the reflective glass 11 faces the driver, the reflective glass 11 remains at its position. By turning the reflective glass 11, the ambient light at two sides and the rear of the vehicle can be reflected to the field of view of the driver, and the driver can observe the road conditions at two sides and the rear of the vehicle in the reflective glass 11 through conventional driving habits.

Referring to FIG. 2 (b) and FIG. 3 (b), when the rearview mirror switches to the display state, the display screen 21 is turned to a side to face the ambient light and face the user. Exemplarily, when the surrounding environment is dark, such as during nighttime, the display state of the rearview mirror is activated, and if the reflective glass 11 faces the driver at this time, the display screen 21 is turned to the side to face the ambient light and face the driver by taking the central rotation axis 23 as a base point. If the display screen 21 faces the driver, the display screen 21 remains at its position. By turning the display screen 21, the driver can observe road conditions at two sides and the rear of the vehicle on the display screen 21 in accordance with conventional driving habits. With this configuration, on the basis of the existing rearview mirror structure, the present disclosure does not need to change the driving habits of the driver, thereby improving the environment effect in poor light of the rearview mirror by only simply turning the display screen 21 and the reflective glass 11. Even if the display screen is damaged, it can switch to the traditional rearview mirror mode, thus meeting the display function under different working conditions and improving the driving safety.

Based on the above embodiments, referring to FIG. 2 and FIG. 3, the turning modes of the reflective assembly 10 and the display assembly 20 includes a first mode and a second mode. The first mode refers to that the reflective assembly 10 and the display assembly 20 of the rearview mirror is automatically controlled to be turned by taking the central rotation axis 23 as a base point. The second mode refers to that the driver manually controls the reflective assembly 10 and the display assembly 20 to be turned by taking the central rotation axis 23 as a base point according to driving requirements. That is, the turning of the reflective assembly 10 and the display assembly 20 may be set to be automatically adjusted, or may be manually adjusted by the driver.

It should be noted that the rearview mirror may further include an automatic control key and the like, which may be in a form of a knob, a key and the like, for example, provided in any conveniently controlled region, at a position of the steering wheel of the vehicle and the cab control screen. The rotation angle of the display screen 21 and the reflective glass 11 can be controlled by pressing the key, rotating the knob, touching the control screen, voice intelligent control and the like, so as to finely adjust the angle of the display screen 21 and the reflective glass 11 facing the driver.

In an embodiment, referring to FIG. 2 and FIG. 3, when the rearview mirror switches to the first mode, the display screen 21 and the reflective glass 11 are automatically turned by 180° by taking a central rotation axis as a base point.

Exemplarily, as shown in FIG. 2, the processor controls the display screen 21 and the reflective glass 11 to be automatically turned by 180° by taking the central rotation axis 23 as a base point according to a preset program, so that the rearview mirror can switch between the reflective state and the display state. In this mode, the display screen 21 and the reflective glass 11 are always combined in a back-to-back manner, and the angles of the display screen 21 and the reflective glass 11 facing the driver are the same. Such a configuration can meet the driver's conventional driving observation habits and facilitate the observation of road width and other conditions.

Referring to FIG. 2 and FIG. 3, when the rearview mirror switches to the second mode, the display screen 21 and the reflective glass 11 are manually turned clockwise by a first angle by taking a central rotation axis as a base point. The first angle is less than or equal to 90°, and the first angle may be a relatively small acute angle, for example, 5° or 8°.

Exemplarily, when the rearview mirror is in the reflective state or the display state, the range of the environmental image observed by the driver during the driving is limited, and even after switching between the display screen 21 and the reflective glass 11, the requirements for the environmental image field of view still cannot be met. The driver can manually trigger the automatic control key, and the processor controls the display screen 21 or the reflective glass 11 to be turned clockwise by 5° by taking the central rotation axis 23 as a base point based on a preset program, so as to finely adjust the range of the environment image observed by the driver. For example, in a case of reversing, turning and the like, when the requirements for the environmental image field of view still cannot be met, the driver can also trigger the automatic control key multiple times to achieve the optimal visual effect. In this mode, the display screen 21 and the reflective glass 11 are combined in a back-to-back manner, but a relative position of the display screen 21 and the reflective glass 11 can be slightly adjusted, and the angles of the display screen 21 and the reflective glass 11 facing the driver can be manually finely adjusted. Such a configuration can meet the requirement of the driver for observing the visual field under special conditions, and has the advantages of flexibility and convenience.

Based on the above embodiments, referring to FIG. 2, the reflective glass 11 has a curved surface, and the display screen 21 has a planar surface. The reflective glass 11 protrudes towards a direction away from the display screen 21.

In an embodiment, when the rearview mirror switches to the reflective state, the convex curved reflective glass 11 has a larger reflective surface, which can reflect the ambient light in a larger field of view to the driver's field of view, thereby increasing the observation range of the driver. In addition, the display screen 21 is planar, such as a conventional planar LCD, which is beneficial for reducing the costs. In some embodiments, although the display screen 21 is planar, the display screen 21 may be controlled by a program to have a function of amplifying the display image. After enlarging the environment image, it is convenient for the driver to observe the situations after the local road conditions are enlarged, thereby improving the display clarity of the local environment image.

Based on the above embodiments, referring to FIG. 3, the reflective glass 11 and the display screen 21 each have a curved surface, the reflective glass 11 protrudes towards a direction away from the display screen 21, and the display screen 21 protrudes towards a direction away from the reflective glass 11. That is, the reflective glass 11 and the display screen 21 form two convex surfaces, which have a larger surface and are conducive to reflecting or displaying a larger range of the environmental image to the driver, making it easier for the driver to observe.

The radius of curvature refers to a radius of a circle at a point on the curve that is closest locally to the curve at a certain point on the curve. The radius of curvature is used to describe the curvature degree of a curve at a certain point. The larger the radius of curvature, the smaller the curvature of the curve at this point; the smaller the radius of curvature, the larger the curvature of the curve at this point.

Based on the foregoing embodiments, referring to FIG. 3, the display screen 21 provided in an embodiment of the present disclosure has a convex surface, the display screen 21 protrudes towards a direction away from the reflective glass 11, and a radius of curvature of the display screen 21 is not suitable for being excessively large, to ensure that an environment image displayed by the display screen 21 has consistency with an environment image reflected by the reflective glass 11. That is, when switching between the display screen 21 and the reflective glass 11, at least the environment image observed by the user remains unchanged, and only the brightness changes.

In a feasible manner, a radius of curvature of the display screen 21 is set to be equal to a radius of curvature of the reflective glass 11. Such a configuration can ensure that the radian of the display surface of the display screen 21 is the same as that of the reflective surface of the reflective glass 11, thereby having a same display effect.

In a feasible manner, a radius of curvature of the display screen 21 is set to be less than a radius of curvature of the reflective glass 11. In this way, by using the display screen 21 with a greater degree of curvature, it is beneficial to increasing the display area of the display screen 21, enlarging the environmental image, thereby improving the convenience of the driver's driving observation.

Based on the above embodiments, referring to FIG. 3, the display area of the display screen 21 may be set to be equal to the reflective area of the reflective glass 11. In this way, the display image observed by the driver from the display screen 21 and the display image observed by the reflective glass 11 have a same size, and there is no difference in the driver's habit of looking at the rearview mirror. If the ambient light is dark, the clarity of the ambient image displayed by the display screen 21 may be improved by increasing the display brightness of the display screen 21.

Based on the above embodiments, referring to FIG. 3, the display area of the display screen 21 may be set to be greater than the reflective area of the reflective glass 11. In this way, the environment image in a small field of view range can be enlarged, the environment image in a large field of view range can be reduced, thereby realizing diverse display of environment images in various field of view ranges, and thus improving the driver's field of view.

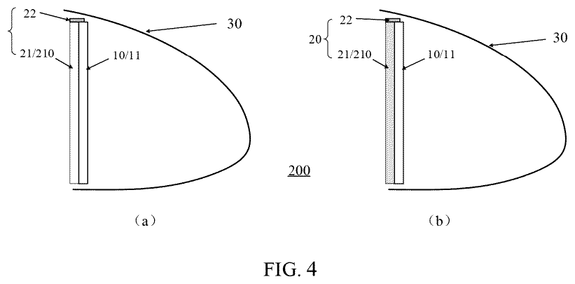

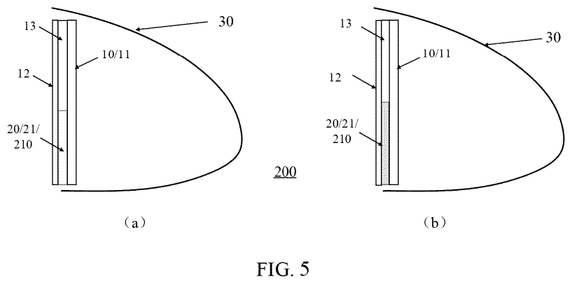

FIG. 4 is a structural diagram of another rearview mirror according to an embodiment of the present disclosure, FIG. 5 is a structural diagram of another rearview mirror according to an embodiment of the present disclosure. Referring to FIG. 4 and FIG. 5, a reflective assembly 10 includes reflective glass 11, and a display assembly 20 includes a display screen 21 and an image collector 22. The display screen 21 includes a transparent display screen 210, and the transparency of the transparent display screen 210 is adjustable.

A transparent display screen is a device that can display an image in a transparent or semi-transparent state, and is almost transparent when no image is displayed, thereby allowing a background image or scene to be displayed through the display screen. The types of the transparent display screen include, but are not limited to, a transparent OLED, a transparent LCD, a transparent Micro LED, and the like, and the working principle of the transparent display screen should be clearly understood by those skilled in the art, and details are not described herein again.

In this embodiment of the present disclosure, a shape of the transparent display screen 210 is one of circular, square, rectangular, irregular shape, etc., which is not limited in embodiments of the present disclosure.

Referring to FIG. 4 (a) and FIG. 5 (a), when the rearview mirror switches to the reflective state, the transparent display screen 210 is turned off, the transparency of the transparent display screen 210 is the first transparency, and the reflective glass 11 reflects the ambient light to the user's field of view. The first transparency may be in an approximately transparent state or a transparent state. When the transparent display screen 210 is turned off, ambient light can pass through the transparent display screen 210 to reach the reflective glass 11, and then be reflected by the reflective glass 11 to the user's field of view.

Referring to FIG. 4 (b) and FIG. 5 (b), when the rearview mirror switches to the display state, the transparent display screen 210 is turned on, the transparency of the transparent display screen 210 is second transparency. The image collector 22 is configured to acquire ambient light and generate an environment image, and the transparent display screen 210 is configured to display the environment image.

The second transparency is less than the first transparency. The second transparency may be an opaque state, and light cannot pass through the transparent display screen 210. In an embodiment, when the ambient light is relatively dark or the user actively activates the display state, the transparent display screen 210 switches from the first transparency to the second transparency, the image collector 22 acquires ambient light at two sides and the rear of the vehicle and generates an ambient image, and the transparent display screen 210 displays the ambient image.

On the basis of the above embodiments, referring to FIG. 4 and FIG. 5, the light-exiting side of the transparent display screen 21 is a side of the transparent display screen 210 facing away from the reflective glass 11. The transparent display screen 210 at least partially overlaps with the reflective glass 11, and the image collector 22 is located at an edge position of the transparent display screen 210 and does not overlap with the reflective glass 11. In an embodiment of the present disclosure, the transparent display screen 210 may be attached to the reflective glass 11, and a light-exiting side of the transparent display screen 210 faces away from the reflective glass 11. The transparent display screen 210 and the reflective glass 11 are fixedly arranged. The reflective assembly 10 and the display assembly 20 are provided in the rearview mirror housing 30. The size of the transparent display screen 210 is smaller than or equal to the size of the reflective glass 11. The transparent display screen 210 and the reflective glass 11 do not need to adopt a rotary switching manner.

In the reflective state, the transparent display screen 210 is in a transparent state, and ambient light passes through the transparent display screen 210 to reach the reflective glass 11, and then is reflected by the reflective glass 11 and passes through the transparent display screen 210 again to reach the user's field of view.

In the display state, the transparent display screen 210 is in an opaque state, the ambient light cannot pass through the transparent display screen 210, an environment image collected by the image collector 22 is displayed, and the transparent display screen 210 displays the environment image.

In FIG. 5, when the size of the transparent display screen 210 is smaller than the size of the reflective glass 11, the transparent display screen 210 is provided at the center of the reflective glass 11 or at a position close to the user, so that the user can conveniently observe the image. Or, the transparent display screen 210 may be encapsulated in an interlayer of the transparent glass 13, and a region 13 between the transparent glass 13 and the reflective glass 11 may be filled with air or transparent resin, to fix the transparent display screen 210.

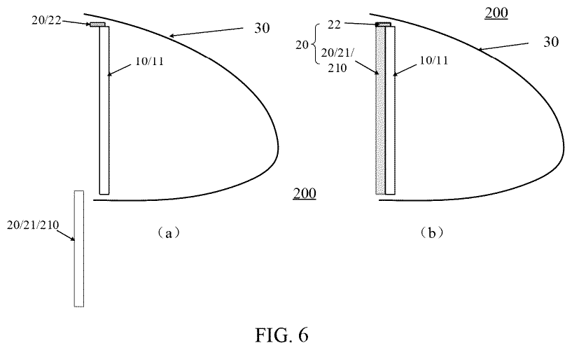

FIG. 6 is a structural diagram of another rearview mirror according to an embodiment of the present disclosure. In another embodiment of the present disclosure, referring to FIG. 6, the transparent display screen 210 and the reflective glass 11 may be non-fixedly arranged. Referring to FIG. 6 (a), in the reflective state, the transparent display screen 210 moves to the non-reflective region. The non-reflective region refers to a certain region that does not block the user from observing the mirror image in the reflective glass 11. It can also be understood that the relative position of the transparent display screen 210 and the reflective glass 11 can be moved.

Referring to FIG. 6 (b), when the rearview mirror is activated to the display state, the transparent display screen 210 is turned on, and the transparent display screen 210 moves to the light path of the ambient light reflected by the reflective glass 11 to the user's field of view. In the embodiments of the present disclosure, different from a fixed design of the transparent display screen 210 and the reflective glass 11 in the related art, the reflective glass 11 may be installed in the rearview mirror housing 30 according to a conventional setting manner, and the transparent display screen 210 may be installed inside the vehicle, and a specific position may be reasonably configured according to requirements. In the display state, the transparent display screen 210 moves from the interior of the vehicle to the light path of the ambient light reflected by the reflective glass 11 to the user's field of view, so as to block the reflective glass 11 and display the environment image. The transparent display screen 210 may also be a common non-transparent display screen, such as an LCD, an OLED, or a Micro LED.

Based on the above embodiments, referring to FIGS. 2-6, the display image of the display assembly 20 is an enlarged image of the environment image. Exemplarily, when the ambient light is relatively dark, the display screen of the display assembly 20 partially amplifies the ambient light image, so that it is beneficial for the driver to observe a partially enlarged clear image of the surrounding road conditions, thereby meeting the driver's observation needs and enhancing driving safety.

On the basis of the above embodiments, referring to FIG. 2 to FIG. 6, the activating mode of the display assembly 20 is a manual mode or an automatic mode, the rearview mirror further includes a lux meter and at least one processor (all shown in FIG. 2 to FIG. 6), and the lux meter is configured to acquire the lux of the ambient light.

The lux is a unit for measuring the illumination intensity, and is used to represent the luminous flux of the visible light received per unit area. A large lux means that the illumination of the area is very bright. The lux meter may be a photosensitive sensor, including but not limited to a light dependent resistor (LDR), a photodiode, a phototransistor, and the like.

The manual mode refers to that the user manually activates the display assembly 20 of the rearview mirror to make it work in the display state. The automatic mode refers to that the processor automatically activates the display assembly 20 of the rearview mirror to make it work in the display state at a preset time, a preset lux or under a certain working condition based on a preset control program.

In the manual mode of the rearview mirror, the processor is configured to activate the display state based on the activation signal. The activation signal may be sent by the user by pressing a button, rotating a knob, touching a control screen, or voice control, and the processor receives the activation signal and controls the display assembly 20 to be turned on based on a preset control program.

In the automatic mode of the rearview mirror, the processor is configured to activate the display state when determining that the lux of the ambient light is lower than a threshold based on the lux of the ambient light. In an embodiment, the lux meter may be provided at the position of the rearview mirror housing 30 without shielding the reflective glass 11 and the display screen 21. The lux meter generates different electric signals by detecting the illumination intensity changes of the ambient light of the surface region of the rearview mirror, calculates the lux, and transmits the lux to the processor. The processor compares the lux with the threshold, and activates the display assembly 20 when determining that the lux of the ambient light is lower than the threshold, that is, the illumination intensity is weak. A high-clarity environment image is displayed by using the display screen 21, thereby improving a display effect of the rearview mirror in a dark light environment.

Exemplarily, with reference to the activating manner of the display assembly 20 in the above embodiments, as shown in FIG. 2 and FIG. 3, the processor controls the display screen 21 to be turned to a side to face the ambient light and face the user, so as to display the environment image. As shown in FIG. 4 and FIG. 5, the processor controls the transparent display screen 210 to switch from the first transparency to the second transparency to display the environment image. As shown in FIG. 6, the processor controls the transparent display screen 210 to move to a light path of the ambient light reflected by the reflective glass 11 to the user's field of view.

The brightness refers to a physical quantity of luminous intensity on a surface of a luminous object, and is usually represented by cd/m² or nit.

Based on the above embodiments, referring to FIG. 2 to FIG. 6, in the display state of the rearview mirror, the processor is further configured to adjust the display brightness of the ambient image on the display screen 21 based on a comparison relationship between the lux of the ambient light and the brightness of the display assembly 20. In the embodiments of the present disclosure, a comparison relationship between lux of ambient light and brightness of the display assembly 20 may be pre-created and stored in the processor. For example, when the lux of the ambient light is low, the display brightness of the display screen is increased. When the lux of the ambient light is high, the display brightness of the display screen is decreased or maintained. It should be noted that, for the display screen, the high brightness means that the interference resistance of the display screen to the working environment is stronger, and the display brightness of the display screen 21 under the lux is adjusted based on the lux in the embodiments of the present disclosure, so that a clearer image and a better visual experience can be provided, thereby improving the display effect of the rearview mirror.

On the basis of the above embodiments, referring to FIGS. 2-6, in the automatic mode of the rearview mirror, the processor is further configured to activate or deactivate the display state based on fixed time. For example, referring to FIG. 2 and FIG. 3, during a time period from 6:00 to 18:00, the ambient light is strong and the field of view is good, the rearview mirror is automatically turned to the reflective state. The reflective glass 11 is turned to the side to face the ambient light and face the user, and reflects the ambient light to the driver's field of view, which can save energy and electricity. During a time period from 18:00 of a previous day to 6:00 of a next day, the ambient light is weak and the field of view is poor, the rearview mirror is automatically activated to the display state, and the display screen 21 is turned to a side to face the ambient light and face the user, to display the ambient image, thereby improving the driving safety.

It should be noted that the fixed time may be reasonably adjusted based on sunrise sunset time, seasons, weather, driver preferences, and the like, which is not limited in embodiments of the present disclosure.

On the basis of the above embodiment, referring to FIG. 2 to FIG. 6, the rearview mirror structure further includes a temperature detection assembly (not shown in the figure), and the temperature detection assembly is provided at a side of the display assembly 20 to acquire the ambient temperature and the temperature of the display assembly 20. The temperature detection assembly may be a temperature sensor, including but not limited to, a thermistor, a thermocouple, an integrated temperature sensor, and the like.

In an embodiment, in the display state of the rearview mirror, the processor is further configured to turn off the display assembly 20 upon determining that the ambient temperature is greater than or equal to the temperature of the display assembly 20. In an embodiment, the temperature sensor detects the ambient temperature and the temperature of the display screen 21 to generate different electrical signals, and transmits the electrical signals to the processor. Upon determining that the ambient temperature is not lower than the temperature threshold of the display screen 21, the processor turns off the display screen 21. In other words, when the ambient temperature is too high, for example, during the noon time in summer, the display screen 21 cannot dissipate heat at this time, and the display screen 21 can be turned off to avoid a risk of screen burning caused by a combination of high ambient temperature and self-generated heat.

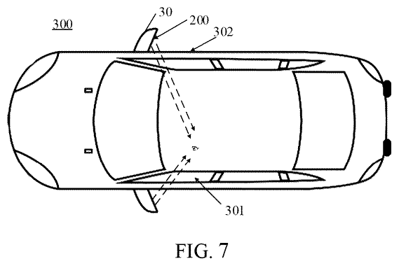

Based on a same inventive concept, an embodiment of the present disclosure further provides a vehicle. FIG. 7 is a diagram illustrating a rearview mirror being applied in a vehicle according to an embodiment of the present disclosure. Referring to FIG. 7, the rearview mirror 200 is assembled in a vehicle 300, and the vehicle 300 shown in the figure is merely exemplary, and does not represent any specific brand or model of a vehicle. The vehicle also includes other vehicle components, such as engine, chassis, doors, steering wheel, and so on, which are not individually listed in the embodiments of the present disclosure. Referring to FIGS. 2-6, the reflective assembly 10 of the rearview mirror includes reflective glass 11, and the display assembly 20 includes a display screen 21 and an image collector 22. The reflective glass 11, the display screen 21 and the image collector 22 also have the beneficial effects of the rearview mirror as described in the above embodiments, which will not be repeated herein.

In an embodiment, in the reflective state of the rearview mirror, the reflective glass 11 reflects the ambient light to the driver's field of view.

In the display state of the rearview mirror, the image collector 22 acquires ambient light and generates the environment image, and the display screen 21 displays the environment image.

Different from the related art, the rearview mirror provided by the embodiment of the present disclosure can switch between the reflective state and the display state according to different driving environments, thereby providing clear road condition information for the driver during driving and improving driving safety of the driver.

On the basis of the above embodiments, referring to FIG. 2, FIG. 3 and FIG. 7, the reflective glass 11 and the display screen 21 of the rearview mirror 200 are located in the rearview mirror housing 30. The light-exiting side of the display screen 21 is a side of the display screen 21 facing away from the reflective glass 11, the image collector 22 is located between the display screen 21 and the reflective glass 11, and the display screen 21 and the reflective glass 11 are turned over by taking a central rotation axis 23 as a base point. By adopting this structural design, the position of the rearview mirror 200 is consistent with the position of the conventional rearview mirror, only the reflective glass 11 and the display screen 21 are turned over and switch, while the driver's viewing angle remains unchanged, thus providing higher adaptability.

Referring to FIG. 2 (a) and FIG. 3 (a), in the reflective state of the rearview mirror, the reflective glass 11 is turned to a side to face the ambient light and face the user. For example, when the light is bright during the day time, the driver observes road conditions at two sides and the rear of the vehicle 300 on the reflective glass 11 according to their conventional driving habits.

Referring to FIG. 2 (b) and FIG. 3 (b), in the display state of the rearview mirror, the display screen 21 is turned to a side to face the ambient light and face the user. For example, in the light is dark during the night time, the driver observes road conditions at two sides and the rear of the vehicle 300 on the display screen 21 through their conventional driving habits. The brightness of the display screen 21 is adjustable, which is beneficial to adjusting the imaging effect of the rearview mirror in the dark light environment and improving the driving safety.

On the basis of the above embodiments, referring to FIG. 4, FIG. 5 and FIG. 7, the display screen 21 includes a transparent display screen 210. The transparency of the transparent display screen 210 is adjustable, and the transparent display screen 210 has the beneficial effects of the rearview mirror as described in the above embodiments, which will not be repeated herein. The reflective glass 11 and the transparent display screen 210 are located in the rearview mirror housing 30, and the rearview mirror housing 30 is located at a left side and a right side of the vehicle 300. The light-exiting side of the display screen 21 is a side of the display screen 21 facing away from the reflective glass 11. By adopting this structural design, the position of the transparent display screen 210 is consistent with the position of the reflective glass 11 of the conventional rearview mirror. When switching between the reflective glass 11 and the transparent display screen 210, the driver's viewing angle will not change, making it easier to adapt.

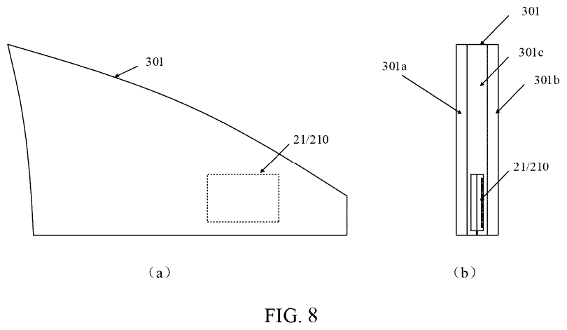

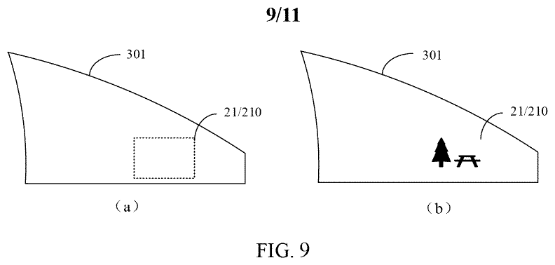

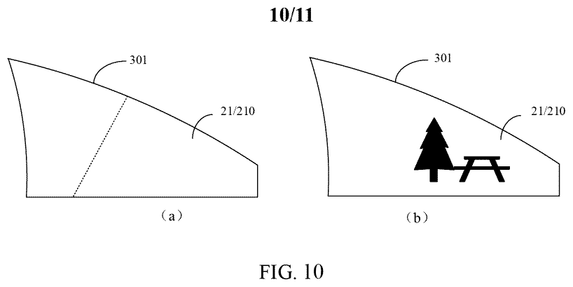

FIG. 8 is a diagram illustrating a display screen being located at a side window glass according to an embodiment of the present disclosure, FIG. 9 is a diagram illustrating closing and opening of the display screen in the front side window glass shown in FIG. 8, FIG. 10 is an another diagram illustrating a display screen being located at a side window glass according to an embodiment of the present disclosure, FIG. 8 (a) is a front view of the side window glass, and FIG. 8 (b) is a sectional view of the side window glass. In another embodiment of the present disclosure, referring to FIG. 7 to FIG. 10, the reflective glass 11 is located in the rearview mirror housing 30, and the display screen 21 is located in at least a partial region of the front side window glass 301 of the cab. The embodiments of the present disclosure break a conventional mode in which the rearview mirror is located at the left side and the right side of the vehicle, the reflective glass 11 and the display screen 21 are separately arranged, and the transparent display screen 210 is hidden in the front side window glass 301, and the image collector 22 is hidden in the rearview mirror housing 30. The transparent display screen 210 can move along with the front side window glass 301.

Referring to FIG. 6, FIG. 7, FIG. 9 (a) and FIG. 10 (a), in the reflective state of the rearview mirror, the transparent display screen 210 is turned off, the transparency of the transparent display screen 210 is the first transparency, and the reflective glass 11 reflects the ambient light to the field of view of the user. In this state, the reflective glass 11 of the rearview mirror is conventionally configured and the transparent display screen 210 is almost transparent, and rising, half-rising, falling and the like of the front side window glass 301 do not affect the display. The driver observes road conditions at two sides and the rear of the vehicle 300 on the reflective glass 11 according to conventional driving habits.

Referring to FIG. 6, FIG. 7, FIG. 9 (b) and FIG. 10 (b), in the display state of the rearview mirror, the transparent display screen 210 is activated, the transparency of the transparent display screen 210 is the second transparency. The image collector 22 acquires ambient light and generates an environment image, and the transparent display screen 210 displays the environment image. The second transparency is less than the first transparency. In this state, the front side window glass 301 rises, the transparent display screen 210 moves to a light path of the ambient light reflected by the reflective glass 11 to the user's field of view, and the driver observes road conditions at two sides and the rear of the vehicle 300 on the transparent display screen 210. It should be noted that the transparent display screen 210, the reflective glass 11, and the driver are aligned in a straight line. The transparent display screen 210 shields the reflective glass 11, especially in a dark environment, the driver can directly observe a high-clarity environment image on the transparent display screen 210, thereby improving the driving safety.

In other embodiments, the transparent display screen 210 may be located in at least a partial region of the rear side window glass of the vehicle, so that passengers can observe road conditions at two sides and the rear of the vehicle, etc. For example, when it is necessary to exit the vehicle by opening the door, it can prevent the door from hitting pedestrians and surrounding objects. When the road condition does not need to be observed, the transparent display screen 210 can play videos, images and the like to provide rich entertainment activities for the driver.

Based on the above embodiments, referring to FIG. 8 (b), when the transparent display screen 210 is located in at least a partial region of the front side window glass 301 of the cab, the front side window glass 301 includes first glass 301a and second glass 301b. The transparent display screen 210 is located between the first glass 301a and the second glass 301b, and a transparent adhesive layer 301c is filled between the first glass 301a and the second glass 301b. In the embodiments of the present disclosure, the transparent display screen 210 is located in an interlayer between the first glass 301a and the second glass 301b of the front side window glass 301, and is filled and fixed by using the transparent adhesive layer 301c.

The position of the transparent display screen 210 may be provided in an edge region or a center region of the front side window glass 301 close to the driver, or may be adjusted according to the driving position of the driver in actual usage. The area of the transparent display screen 210 in the front side window glass 301 may be reasonably adjusted according to the viewing habit of the driver, which is not limited in the embodiments of the present disclosure. Referring to FIG. 10 (b), the environment image displayed by the transparent display screen 210 may be an enlarged image for the driver to observe.

It should be noted that the display screen provided in embodiments of the present disclosure may not only display road widths at two sides and the rear of the vehicle, but also play a video, an image, and the like by using the vehicle-mounted controller, to provide rich entertainment activities for the driver during non-driving rest. The activating mode of the display screen is not limited to mechanical control, but also can be combined with existing voice intelligent control and the like to provide a rich, convenient and rapid control mode for the driver, which is not limited in embodiments of the present disclosure.

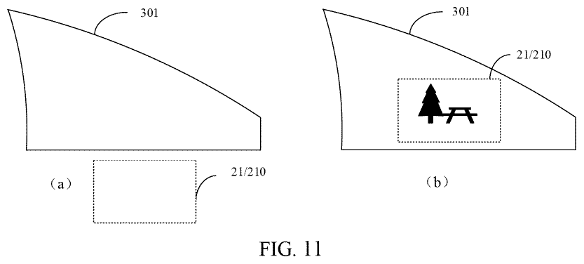

FIG. 11 is a diagram illustrating a display screen being located in a door 302 of a vehicle according to an embodiment of the present disclosure. In another embodiment, referring to FIG. 6, FIG. 7 and FIG. 11, the reflective glass 11 is located in the rearview mirror housing 30, and the display screen 21 is located in the door 302 of a driving cab of a vehicle.

In an embodiment, referring to FIG. 6 (a), FIG. 7 and FIG. 11 (a), in a reflective state of the rearview mirror, the display screen 21 is hidden in a door 302 of a driving cab of a vehicle, and the driver observes road conditions at two sides and the rear of the vehicle 300 on the reflective glass 11 according to conventional driving habits.

Referring to FIG. 6 (b), FIG. 7 and FIG. 11 (b), in the display state of the rearview mirror, the display screen 21 is activated, and the display screen 21 moves from the interior of the door 302 of the driving cab of the vehicle to a light path of the ambient light reflected by the reflective glass 11 to the user's field of view. The driver observes the road conditions at two sides and the rear of the vehicle 300 on the transparent display screen 210, it can be used in various road conditions, which is beneficial to improving the high-clarity road condition information at two sides and the rear of the vehicle and the driving comfort and safety.

The type of the display screen 21 is not limited, and a common non-transparent display screen, such as an LCD, an OLED, or a Micro LED may be used.

It should be noted that, the above description merely described some preferred embodiments of the present disclosure and the technical principles used therein, and the present disclosure shall not be limited to the embodiments described herein, and any apparent alterations, modification and substitutions can be made without departing from a scope of the present disclosure. Therefore, although the present disclosure has been described in detail by way of the above embodiments, the present disclosure is not limited only to the above embodiments, and more other equivalent embodiments may be included without departing from a concept of the present disclosure, and the scope of the present disclosure is determined by the scope of the appended claims.

What is claimed is:

1. A rearview mirror, comprising:
a reflective assembly; and
a display assembly;
wherein states of the rearview mirror comprise a reflective state and a display state;
in the reflective state, the reflective assembly is activated and configured to reflect ambient light to a field of view of a user; and
in the display state, the display assembly is activated and configured to acquire ambient light and generate an environment image for display.

2. The rearview mirror according to claim 1, wherein
the reflective assembly comprises reflective glass, and the display assembly comprises a display screen and an image collector; and the image collector is configured to acquire the ambient light and generate the environment image, and the display screen is configured to display the environment image;
a light-exiting side of the display screen is a side of the display screen facing away from the reflective glass, the image collector is located between the display screen and the reflective glass, and the display screen and the reflective glass are turned over by taking a central rotation axis as a base point;
in the reflective state, the reflective glass is turned to a side to face the ambient light and face the user; and
in the display state, the display screen is turned to a side to face the ambient light and face the user.

3. The rearview mirror according to claim 2, wherein
turning modes of the reflective assembly and the display assembly comprise a first mode and a second mode,
in the first mode, the display screen and the reflective glass are automatically turned by 180° by taking a central rotation axis as a base point; and
in the second mode, the display screen and the reflective glass are manually turned clockwise by a first angle by taking a central rotation axis as a base point, the first angle being less than or equal to 90°.

4. The rearview mirror according to claim 2, wherein the reflective glass comprises a curved surface, the display screen comprises a planar surface, and the reflective glass protrudes towards a direction away from the display screen.

5. The rearview mirror according to claim 2, wherein each of the reflective glass and the display screen comprises a curved surface, the reflective glass protrudes towards a direction away from the display screen, and the display screen protrudes towards a direction away from the reflective glass.

6. The rearview mirror according to claim 2, wherein a radius of curvature of the display screen is less than or equal to a radius of curvature of the reflective glass.

7. The rearview mirror according to claim 2, wherein a display area of the display screen is greater than or equal to a reflective area of the reflective glass.

8. The rearview mirror according to claim 1, wherein
the reflective assembly comprises reflective glass, the display assembly comprises a display screen and an image collector, the display screen comprises a transparent display screen, and transparency of the transparent display screen is adjustable;
in the reflective state, the transparent display screen is turned off, the transparency of the transparent display screen is first transparency, and the reflective glass reflects ambient light to the field of view of the user; and
in the display state, the transparent display screen is turned on, the transparency of the transparent display screen is second transparency, the image collector is configured to acquire ambient light and generate an environment image, the transparent display screen is configured to display the environment image, and the second transparency is less than the first transparency.

9. The rearview mirror according to claim 8, wherein
a light-exiting side of the transparent display screen is a side of the transparent display screen facing away from the reflective glass; and
the transparent display screen at least partially overlaps with the reflective glass, and the image collector is located at an edge position of the transparent display screen and does not overlap with the reflective glass.

10. The rearview mirror according to claim 8, wherein
in the display state, the transparent display screen moves to a light path of ambient light reflected by the reflective glass to the field of view of the user.

11. The rearview mirror according to claim 1, wherein a display image of the display assembly is an enlarged image of the environment image.

12. The rearview mirror according to claim 1, wherein
an activation mode of the display assembly is a manual mode or an automatic mode; the rearview mirror further comprises a lux meter and at least one processor, and the lux is configured to acquire lux of the ambient light;
in the manual mode, the at least one processor is configured to activate the display state based on an activation signal; and
in the automatic mode, the at least one processor is configured to activate the display state upon determining that the lux of ambient light is lower than a threshold based on the lux of the ambient light.

13. The rearview mirror according to claim 12, wherein in the display state, the at least one processor is further configured to adjust display brightness of the ambient image on the display screen based on a comparison relationship between the lux of the ambient light and brightness of the display assembly.

14. The rearview mirror according to claim 12, wherein in the automatic mode, the at least one processor is further configured to activate or turn off the display state based on fixed time.

15. The rearview mirror according to claim 12, wherein
the rearview mirror further comprises a temperature detection assembly, and the temperature detection assembly is provided at a side of the display assembly and configured to acquire an ambient temperature and a temperature of the display assembly; and
in the display state, the at least one processor is further configured to turn off the display assembly upon determining that the ambient temperature is greater than or equal to the temperature of the display assembly.

16. A vehicle, comprising a rearview mirror comprising:
a reflective assembly; and
a display assembly;
wherein states of the rearview mirror comprise a reflective state and a display state;
in the reflective state, the reflective assembly is activated and configured to reflect ambient light to a field of view of a user; and
in the display state, the display assembly is activated and configured to acquire ambient light and generate an environment image for display;
wherein,
the reflective assembly comprises reflective glass, the display assembly comprises a display screen and an image collector,
in the reflective state, the reflective glass reflects ambient light to a field of view of a driver; and
in the display state, the image acquirer acquires ambient light and generates an environment image, and the display screen displays the environment image.

17. The vehicle according to claim 16, wherein
both the reflective glass and the display screen are located in a rearview mirror housing,
a light-exiting side of the display screen is a side of the display screen facing away from the reflective glass; the image collector is located between the display screen and the reflective glass, and the display screen and the reflective glass are turned over by taking a central rotation axis as a base point;
in the reflective state, the reflective glass is turned to a side to face the ambient light and face the user; and
in the display state, the display screen is turned to a side to face the ambient light and face the user.

18. The vehicle according to claim 16, wherein
the display screen comprises a transparent display screen, and transparency of the transparent display screen is adjustable;
both the reflective glass and the transparent display screen are located in a rearview mirror housing, and a light-exiting side of the display screen is a side of the display screen facing away from the reflective glass; or, the reflective glass is located in a rearview mirror housing, and the display screen is located in at least a partial area of front side window glass of a cab;
in the reflective state, the transparent display screen is turned off, transparency of the transparent display screen is first transparency, and the reflective glass reflects ambient light to the field of view of the user; and
in the display state, the transparent display screen is turned on, transparency of the transparent display screen is second transparency, the image collector is configured to acquire ambient light and generate an environment image, the transparent display screen is configured to display the environment image, and the second transparency is less than the first transparency.

19. The vehicle according to claim 18, wherein in a case that the display screen is located in at least a partial area of front side window glass of a cab, the front side window glass comprises first glass and second glass, the transparent display screen is located between the first glass and the second glass, and a transparent adhesive layer is filled between the first glass and the second glass.

20. The vehicle according to claim 16, wherein
the reflective glass is located in a rearview mirror housing, and the display screen is located inside a door of a driving cab of the vehicle, and
in the display state, the display screen moves to a light path of ambient light reflected by the reflective glass to the field of view of the user.
